(19) United States
(12) Patent Application Publication
(10) Pub. No.: US 2025/0260210 A1
(43) Pub. Date: Aug. 14, 2025

(54) FREQUENCY STABILIZATION CIRCUIT, FREQUENCY STABILIZATION METHOD, AND OPTICAL COMB GENERATOR

(71) Applicant: ADVANTEST CORPORATION, Tokyo (JP)

(72) Inventor: Takanori OKADA, Miyagi (JP)

(21) Appl. No.: 19/170,019

(22) Filed: Apr. 3, 2025

Related U.S. Application Data
(63) Continuation of application No. PCT/JP2022/044838, filed on Dec. 6, 2022.

(51) Int. Cl. H01S 3/13; H01S 3/067; H01S 3/1106

(52) U.S. Cl. CPC H01S 3/1305; H01S 3/067; H01S 3/1106

(57) ABSTRACT

Provided is a frequency stabilization circuit including: an offset frequency detection unit which detects a carrier envelope offset frequency in an optical comb output from a resonator of a mode-locked fiber laser; a beat frequency detection unit which detects a beat frequency generated by interference between an optical spectrum as a reference in the optical comb and wavelength reference laser light; a first feedback control unit which controls a resonator length in the mode-locked fiber laser based on a first error signal; a second feedback control unit which controls excitation light power in the mode-locked fiber laser based on a second error signal; and a third feedback control unit which controls a resonator length in the mode-locked fiber laser based on a third error signal.

The contents of the following patent application(s) are incorporated herein by reference: NO. PCT/JP2022/044838 filed in WO on Dec. 6, 2022.

### BACKGROUND

### 1. Technical Field

The present invention relates to a frequency stabilization circuit, a frequency stabilization method, and an optical comb generator.

### 2. Related Art

Patent Document 1 describes “providing a pulse laser light source capable of stabilizing absolute frequencies in all longitudinal oscillation modes”.

### PRIOR ART DOCUMENTS

### Patent Documents

Patent Document 1: Japanese Patent Application Publication No. 2008-251723
Patent Document 2: Japanese Patent Application Publication No. 2006-179779
Patent Document 3: Japanese Patent Application Publication No. 2009-130347
Patent Document 4: Japanese Patent Application Publication No. 2018-205546

### Non-Patent Documents

Non-Patent Document 1: JUNGWON Kim et al., Ultralow-noise mode-locked fiber lasers and frequency combs: principles, status, and applications
Non-Patent Document 2: Wolfgang Hansel et al., All Polarization-maintaining fiber laser architecture for robust femtosecond pulse generation

### BRIEF DESCRIPTION OF THE DRAWINGS

FIG. 1 illustrates a configuration example of an optical comb generator 10 including a mode-locked fiber laser 20 and a frequency stabilization circuit 100 according to the present embodiment.

FIG. 2 illustrates a resonator configuration example of a mode-locked fiber laser 20.

FIG. 3 illustrates a configuration example of an offset frequency detection unit 300 included in the frequency stabilization circuit 100 according to the present embodiment.

FIG. 4 illustrates a configuration example of a beat frequency detection unit 400 included in the frequency stabilization circuit 100 according to the present embodiment.

FIG. 5 illustrates a configuration example of a first feedback control unit 500 included in the frequency stabilization circuit 100 according to the present embodiment.

FIG. 6 illustrates a configuration example of a second feedback control unit 600 included in the frequency stabilization circuit 100 according to the present embodiment.

FIG. 7 illustrates a configuration example of a third feedback control unit 700 included in the frequency stabilization circuit 100 according to the present embodiment.

FIG. 8 illustrates a state where a carrier envelope offset frequency fceo is detected by a self-reference method.

FIG. 9 illustrates a state where the carrier envelope offset frequency fceo and a beat frequency fbeat are simultaneously locked.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

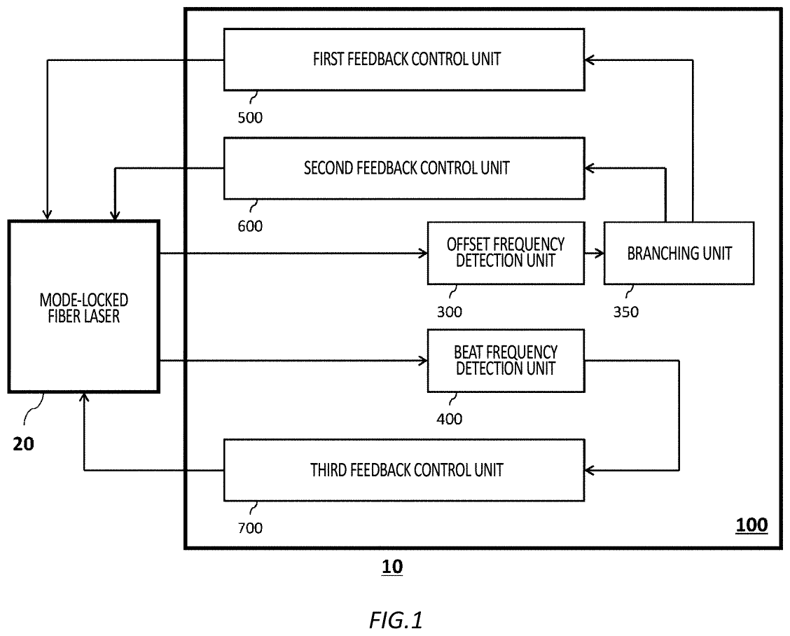

FIG. 1 illustrates a configuration example of an optical comb generator 10 including a mode-locked fiber laser 20 and a frequency stabilization circuit 100 according to the present embodiment. In general, when a mode-locked fiber laser is used as an optical comb light source, simultaneous locking of a carrier envelope offset frequency fceo and a beat frequency fbeat is required. The frequency stabilization circuit 100 according to the present embodiment stabilizes the carrier envelope offset frequency fceo and the beat frequency fbeat, thereby enabling simultaneous locking of the carrier envelope offset frequency fceo and the beat frequency fbeat over a long period of time.

The frequency stabilization circuit 100 according to the present embodiment is provided. In addition, there is provided the optical comb generator 10 including the mode-locked fiber laser 20 and the frequency stabilization circuit 100 according to the present embodiment.

The frequency stabilization circuit 100 may include an offset frequency detection unit 300, a branching unit 350, a beat frequency detection unit 400, a first feedback control unit 500, a second feedback control unit 600, and a third feedback control unit 700.

The offset frequency detection unit 300 detects the carrier envelope offset frequency fceo in an optical comb output from a resonator of the mode-locked fiber laser 20. Details of the offset frequency detection unit 300 will be described later. The offset frequency detection unit 300 supplies, to the branching unit 350, a signal corresponding to the detected carrier envelope offset frequency fceo, for example, a pulse signal having a frequency of the carrier envelope offset frequency fceo.

The branching unit 350 branches the signal corresponding to the carrier envelope offset frequency fceo into at least two, supplies one to the first feedback control unit 500, and supplies another to the second feedback control unit 600.

The beat frequency detection unit 400 detects the beat frequency fbeat which is generated by interference between an optical spectrum as a reference in the optical comb output from the resonator of the mode-locked fiber laser 20 and wavelength reference laser light. Details of the beat frequency detection unit 400 will be described later. The beat frequency detection unit 400 supplies, to the third feedback control unit 700, a signal corresponding to the detected beat frequency fbeat, for example, a pulse signal having a frequency of the beat frequency fbeat.

The first feedback control unit 500 controls a resonator length in the mode-locked fiber laser 20 based on a first error signal indicating an error of the carrier envelope offset frequency fceo with respect to a reference frequency. Details of the first feedback control unit 500 will be described later.

The second feedback control unit 600 controls excitation light power in the mode-locked fiber laser 20 based on a second error signal indicating an error of the carrier envelope offset frequency fceo with respect to the reference frequency. Details of the second feedback control unit 600 will be described later.

The third feedback control unit 700 controls the resonator length in the mode-locked fiber laser 20 based on a third error signal indicating an error of the beat frequency fbeat with respect to the reference frequency. Details of the third feedback control unit 700 will be described later.

In addition, a frequency stabilization method according to the present embodiment is provided. The frequency stabilization method may include: detecting the carrier envelope offset frequency fceo in the optical comb output from the resonator of the mode-locked fiber laser 20; detecting the beat frequency fbeat generated by interference between the optical spectrum as the reference in the optical comb output from the resonator of the mode-locked fiber laser 20 and the wavelength reference laser light; controlling the resonator length in the mode-locked fiber laser 20 based on the first error signal indicating the error of the carrier envelope offset frequency fceo with respect to the reference frequency; controlling the excitation light power in the mode-locked fiber laser 20 based on the second error signal indicating the error of the carrier envelope offset frequency fceo with respect to the reference frequency; and controlling the resonator length in the mode-locked fiber laser 20 based on the third error signal indicating the error of the beat frequency fbeat with respect to the reference frequency.

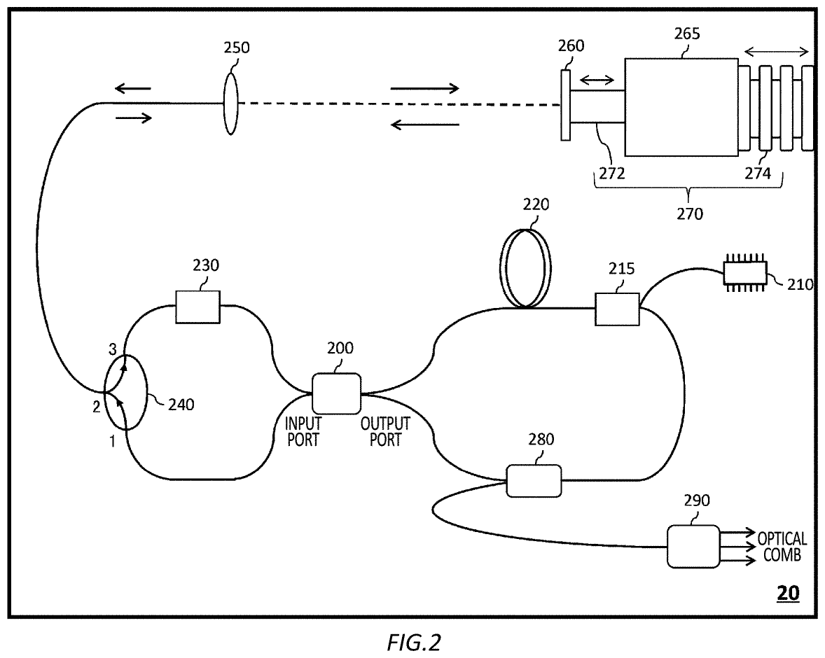

FIG. 2 illustrates a configuration example of the resonator of the mode-locked fiber laser 20. In this drawing, a case where the mode-locked fiber laser 20 is a figure-eight shaped laser in which two input ports and two output ports of a multi-port optical coupler 200 are connected in a figure-eight shape by polarization maintaining fibers (PMF) is illustrated as an example. However, the present invention is not limited thereto. The mode-locked fiber laser 20 may have a shape (for example, a figure-nine shape) different from the figure-eight shape, or each element may be connected by an optical fiber (for example, a single mode fiber (SMF)) different from the polarization maintaining fiber.

The mode-locked fiber laser 20 may include, in the resonator, the multi-port optical coupler 200, a first excitation light source 210, a first wavelength division multiplexing filter 215, a first optical amplification fiber 220, an optical modulator 230, an optical circulator 240, a collimating lens 250, a reflection mirror 260, a support member 265, an actuator 270, an output optical coupler 280, and an optical brancher 290.

The multi-port optical coupler 200 has a plurality of input ports and a plurality of output ports, and branches and merges light. In this drawing, a case where the multi-port optical coupler 200 is a 2×2 port optical coupler having two input ports and two output ports is illustrated as an example. One of the input ports is connected to the optical modulator 230 via the polarization maintaining fiber. Another of the input ports is connected to a first port of the optical circulator 240 via the polarization maintaining fiber. One of the output ports is connected to the first optical amplification fiber 220 via the polarization maintaining fiber. Another of the output ports is connected to the output optical coupler 280 via the polarization maintaining fiber.

The first excitation light source 210 generates excitation light and gives energy necessary for oscillating a laser to an amplification medium. The first excitation light source 210 may be, for example, a pump laser diode having a center wavelength of 980 nm. Optical power output from the first excitation light source 210 changes according to an injected current. Therefore, it is possible to control the excitation light power by controlling the current applied to the first excitation light source 210. An output of the first excitation light source 210 is connected to the first wavelength division multiplexing filter 215 via the polarization maintaining fiber.

The excitation light is input to the first wavelength division multiplexing filter 215. The first wavelength division multiplexing filter 215 may be, for example, a polarization maintaining wavelength division multiplexing (WDM) filter (also referred to as “WDM coupler”) which multiplexes light beams of different wavelengths by using an optical multilayer film filter. One end of the first wavelength division multiplexing filter 215 is connected to the first excitation light source 210 and the output optical coupler 280 via the polarization maintaining fiber. Another end of the first wavelength division multiplexing filter 215 is connected to the first optical amplification fiber 220 via the polarization maintaining fiber.

The first optical amplification fiber 220 amplifies light by being excited by the excitation light. The first optical amplification fiber 220 may be, for example, an erbium (Er)-doped fiber. One end of the first optical amplification fiber 220 is connected to the first wavelength division multiplexing filter 215 via the polarization maintaining fiber. Another end of the first optical amplification fiber 220 is connected to the multi-port optical coupler 200 via the polarization maintaining fiber.

The optical modulator 230 modulates a phase of light propagating in the resonator. The optical modulator 230 may be, for example, an electro-optical modulator (EOM) in which an element exhibiting an electro-optical effect is used to modulate a phase of light. Such an electro-optical effect may be a Pockels effect in which a refractive index changes due to a change in a polarizability inside a substance when a voltage is applied to the substance from outside. In such an optical modulator 230, an optical path length changes according to the applied voltage. Therefore, it is possible to control the resonator length by controlling the voltage applied to the optical modulator 230. One end of the optical modulator 230 is connected to the multi-port optical coupler 200 via the polarization maintaining fiber. Another end of the optical modulator 230 is connected to the optical circulator 240 via the polarization maintaining fiber.

The optical circulator 240 includes the first port, a second port, and a third port, emits, from the second port, light incident on the first port, and emits, from the third port, light incident on the second port. The first port is connected to the multi-port optical coupler 200 via the polarization maintaining fiber. The second port is connected to the collimating lens 250 via the polarization maintaining fiber. The third port is connected to the optical modulator 230 via the polarization maintaining fiber.

The collimating lens 250 outputs light of the fiber as collimated light and inputs the collimated light to the fiber. The collimating lens 250 is connected to the second port of the optical circulator 240 via the polarization maintaining fiber. In addition, the collimating lens 250 is provided to face the reflection mirror 260. Therefore, the collimating lens 250 outputs, to the reflection mirror 260, the light of the polarization maintaining fiber connected to the second port of the optical circulator 240 as collimated light, and inputs, to the polarization maintaining fiber, the collimated light reflected from the reflection mirror 260.

The reflection mirror 260 reflects light. The reflection mirror 260 may be a total reflection mirror which reflects all light. The reflection mirror 260 is provided to face the collimating lens 250. Therefore, the reflection mirror 260 reflects the light emitted from the second port of the optical circulator 240 to be incident on the second port of the optical circulator 240 again. That is, the reflection mirror 260 may function as a folding mirror in the resonator.

The support member 265 supports the reflection mirror 260 so as to face the collimating lens 250. The support member 265 is connected to a housing via a stepping motor 274.

The actuator 270 can modify a position of the reflection mirror 260 along an optical axis direction. The actuator 270 may be at least one of a piezoelectric element 272 or the stepping motor 274.

The piezoelectric element 272 is a piezoelectric element to which the reflection mirror 260 is attached. The piezoelectric element 272 may be interposed, for example, between the reflection mirror 260 and the support member 265. Such a piezoelectric element 272 is deformed according to an applied voltage. For this reason, a distance between the reflection mirror 260 and the support member 265 changes. Therefore, it is possible to control the resonator length by controlling the voltage applied to the piezoelectric element 272.

The stepping motor 274 moves, relative to the housing, the support member 265 which supports the reflection mirror 260. The stepping motor 274 may be interposed, for example, between the support member 265 and the housing. In such a stepping motor 274, an output shaft of the motor rotates according to a given pulse signal. For this reason, a relative position of the support member 265 with respect to the housing changes. Therefore, it is possible to control the resonator length by controlling the pulse signal given to the stepping motor 274.

The output optical coupler 280 outputs the optical comb generated in the resonator. One end of the output optical coupler 280 is connected to the first wavelength division multiplexing filter 215 via the polarization maintaining fiber. Another end of the output optical coupler 280 is connected to the multi-port optical coupler 200 and the optical brancher 290 via the polarization maintaining fiber.

The optical brancher 290 branches the optical comb generated in the resonator into a plurality of paths. In this drawing, a case where the optical brancher 290 is a three-way brancher which branches an optical comb into three is illustrated as an example. One end of the optical brancher 290 is connected to the output optical coupler 280. Another end of the optical brancher 290 is branched into three, and two branch paths thereof are respectively connected via the polarization maintaining fiber to the offset frequency detection unit 300 and the beat frequency detection unit 400 in the frequency stabilization circuit 100 according to the present embodiment. In addition, the remaining one branch path is connected to an output of the optical comb generator 10 via the polarization maintaining fiber.

For example, when such a mode-locked fiber laser 20 is used as the optical comb light source, the frequency stabilization circuit 100 according to the present embodiment stabilizes the carrier envelope offset frequency fceo and the beat frequency fbeat, thereby enabling simultaneous locking of the carrier envelope offset frequency fceo and the beat frequency fbeat over a long period of time. Now, each block in the frequency stabilization circuit 100 according to the present embodiment will be described in detail.

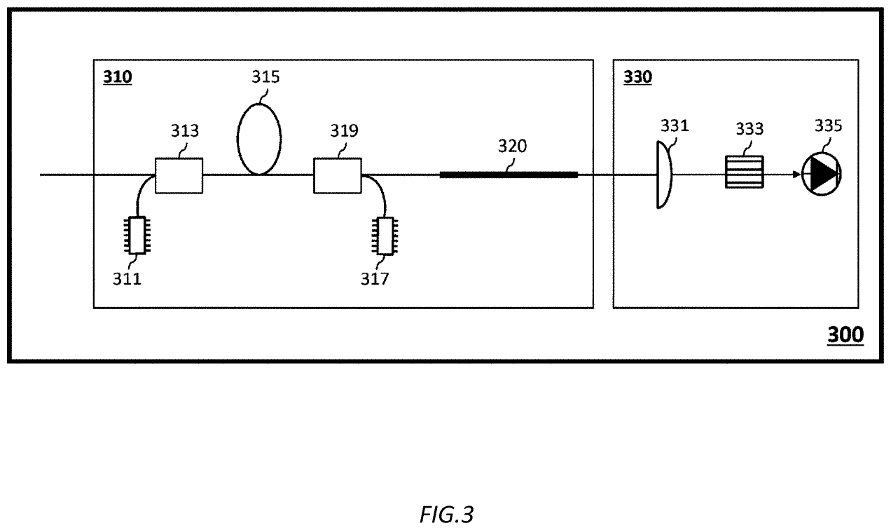

FIG. 3 illustrates a configuration example of the offset frequency detection unit 300 included in the frequency stabilization circuit 100 according to the present embodiment. The offset frequency detection unit 300 includes an octave comb generation unit 310 and an offset frequency observation unit 330.

The octave comb generation unit 310 generates an octave comb by expanding the optical spectrum of the optical comb output from the resonator of the mode-locked fiber laser 20 by an octave or more. The octave comb generation unit 310 may include a second excitation light source 311, a second wavelength division multiplexing filter 313, a second optical amplification fiber 315, a third excitation light source 317, a third wavelength division multiplexing filter 319, and a highly nonlinear fiber 320.

The second excitation light source 311 generates excitation light. The second excitation light source 311 may be provided in front of the second optical amplification fiber 315 and function as a forward excitation light source. An output of the second excitation light source 311 is connected to the second wavelength division multiplexing filter 313 via the polarization maintaining fiber.

The excitation light is input to the second wavelength division multiplexing filter 313. The second wavelength division multiplexing filter 313 may be, for example, a polarization maintaining WDM filter. One end of the second wavelength division multiplexing filter 313 is connected to the second excitation light source 311 and a first branch path of the optical brancher 290 via the polarization maintaining fiber. Another end of the second wavelength division multiplexing filter 313 is connected to the second optical amplification fiber 315 via the polarization maintaining fiber.

The second optical amplification fiber 315 amplifies light by being excited by the excitation light. The second optical amplification fiber 315 may be, for example, an erbium-doped fiber. One end of the second optical amplification fiber is connected to the second wavelength division multiplexing filter 313 via the polarization maintaining fiber. Another end of the second optical amplification fiber 315 is connected to the third wavelength division multiplexing filter 319 via the polarization maintaining fiber.

The third excitation light source 317 generates excitation light. The third excitation light source 317 may be provided behind the second optical amplification fiber 315 and function as a backward excitation light source. An output of the third excitation light source 317 is connected to the third wavelength division multiplexing filter 319 via the polarization maintaining fiber.

The excitation light is input to the third wavelength division multiplexing filter 319. The third wavelength division multiplexing filter 319 may be, for example, a polarization maintaining WDM filter. One end of the third wavelength division multiplexing filter 319 is connected to the second optical amplification fiber 315 via the polarization maintaining fiber. Another end of the third wavelength division multiplexing filter 319 is connected to the third excitation light source 317 and the highly nonlinear fiber 320 via the polarization maintaining fiber.

In the octave comb generation unit 310, the second excitation light source 311, the second wavelength division multiplexing filter 313, the second optical amplification fiber 315, the third excitation light source 317, and the third wavelength division multiplexing filter 319 function as an optical amplifier unit which amplifies output power of the optical comb.

The highly nonlinear fiber 320 expands the spectrum of the optical comb. For example, the highly nonlinear fiber 320 generates an octave comb by broadening the spectrum of the optical comb amplified by the optical amplifier unit to one octave or more. One end of the highly nonlinear fiber 320 is connected to the third wavelength division multiplexing filter 319 via the polarization maintaining fiber. Another end of the highly nonlinear fiber 320 is connected to the offset frequency observation unit 330.

The offset frequency observation unit 330 observes the carrier envelope offset frequency fceo by using the octave comb. The offset frequency observation unit 330 may include a lens 331, a PPLN waveguide 333, and a first photodiode 335.

One end of the lens 331 is connected to the highly nonlinear fiber 320 via the polarization maintaining fiber. The lens 331 optically couples the PPLN waveguide 333 to the polarization maintaining fiber.

The PPLN waveguide 333 is an optical waveguide made of periodically poled lithium niobate (PPLN). The PPLN waveguide 333 generates a second harmonic by a second order nonlinear effect.

The first photodiode 335 observes the carrier envelope offset frequency fceo by interference between a second harmonic 2fn of a nth mode frequency in the optical comb and a 2nth mode frequency f2n in the optical comb. Such a method is called an f-2f self-reference method. Details of the self-reference method will be described later.

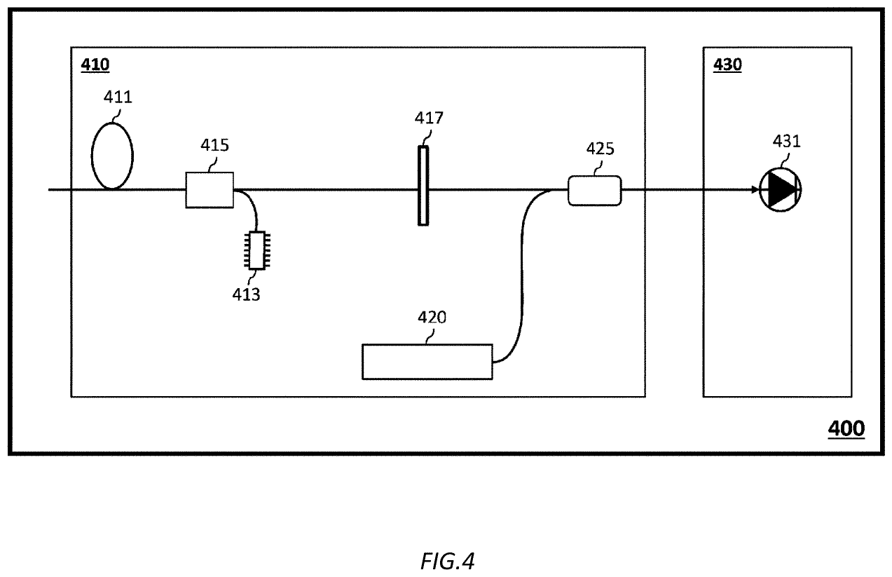

FIG. 4 illustrates a configuration example of the beat frequency detection unit 400 included in the frequency stabilization circuit 100 according to the present embodiment. The beat frequency detection unit 400 includes an optical multiplexing unit 410 and a beat frequency observation unit 430.

The optical multiplexing unit 410 multiplexes the optical comb and the wavelength reference laser light. The optical multiplexing unit 410 may include a fourth optical amplification fiber 411, a fourth excitation light source 413, a fourth wavelength division multiplexing filter 415, an optical band pass filter 417, a wavelength reference laser 420, and an optical multiplexer 425.

The fourth optical amplification fiber 411 amplifies light by being excited by the excitation light. The fourth optical amplification fiber 411 may be, for example, an erbium-doped fiber. One end of the fourth optical amplification fiber 411 is connected to a second branch path of the optical brancher 290 via the polarization maintaining fiber. Another end of the fourth optical amplification fiber 411 is connected to the fourth wavelength division multiplexing filter 415 via the polarization maintaining fiber.

The fourth excitation light source 413 generates excitation light. The fourth excitation light source 413 may be provided behind the fourth optical amplification fiber 411 and function as a backward excitation light source. An output of the fourth excitation light source 413 is connected to the fourth wavelength division multiplexing filter 415 via the polarization maintaining fiber. The excitation light is input to the fourth wavelength division multiplexing filter 415. The fourth wavelength division multiplexing filter 415 may be, for example, a polarization maintaining WDM filter. One end of the fourth wavelength division multiplexing filter 415 is connected to the fourth optical amplification fiber 411 via the polarization maintaining fiber. Another end of the fourth wavelength division multiplexing filter 415 is connected to the fourth excitation light source 413 and the optical band pass filter 417 via the polarization maintaining fiber.

In the optical multiplexing unit 410, the fourth optical amplification fiber 411, the fourth excitation light source 413, and the fourth wavelength division multiplexing filter 415 function as an optical amplifier unit which amplifies output power of the optical comb.

The optical band pass filter 417 extracts an optical spectrum as a reference. For example, the optical band pass filter 417 transmits only a specific wavelength as the reference in the optical comb amplified by the optical amplifier unit, and blocks light of other wavelengths. One end of the optical band pass filter 417 is connected to the fourth wavelength division multiplexing filter 415 via the polarization maintaining fiber. Another end of the optical band pass filter 417 is connected to the optical multiplexer 425 via the polarization maintaining fiber.

The wavelength reference laser 420 emits wavelength reference laser light. The wavelength reference laser 420 may be, for example, an external cavity semiconductor laser (ECLD: External Cavity Laser Diode). An output of the wavelength reference laser 420 is connected to the optical multiplexer 425 via the polarization maintaining fiber.

The optical multiplexer 425 multiplexes the optical spectrum as the reference in the optical comb and the wavelength reference laser light. The optical multiplexer 425 multiplexes, for example, the optical spectrum extracted by the optical band pass filter 417 and the wavelength reference laser light emitted from the wavelength reference laser 420. One end of the optical multiplexer 425 is connected to the optical band pass filter 417 and the wavelength reference laser 420 via the polarization maintaining fiber. Another end of the optical multiplexer 425 is connected to the beat frequency observation unit 430.

The beat frequency observation unit 430 observes a beat frequency using the multiplexed light. The beat frequency observation unit 430 may include a second photodiode 431.

The second photodiode 431 observes the beat frequency fbeat generated by interference between the optical spectrum as the reference in the optical comb and the wavelength reference laser light.

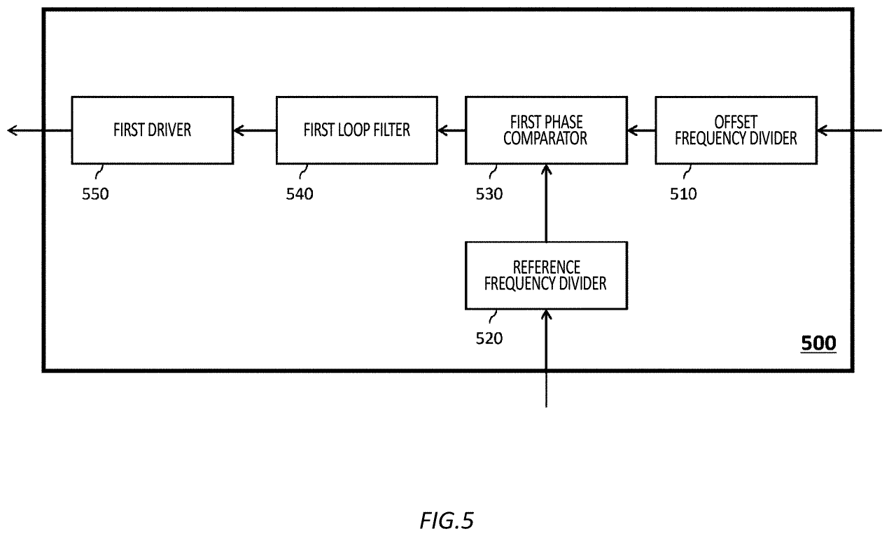

FIG. 5 illustrates a configuration example of the first feedback control unit 500 included in the frequency stabilization circuit 100 according to the present embodiment. The first feedback control unit 500 includes an offset frequency divider 510, a reference frequency divider 520, a first phase comparator 530, a first loop filter 540, and a first driver 550.

The offset frequency divider 510 divides the carrier envelope offset frequency fceo. A signal corresponding to the carrier envelope offset frequency fceo detected by the offset frequency detection unit 300, for example, a pulse signal which has a frequency of the carrier envelope offset frequency fceo and is one of the signals branched by the branching unit 350 is input to the offset frequency divider 510. Then, the offset frequency divider 510 divides the carrier envelope offset frequency fceo by using the input signal. At this time, the offset frequency divider 510 may determine a frequency division ratio according to an operation band frequency of a device to be controlled by the first feedback control unit 500. Such a frequency division ratio may be a value determined in advance for each device, may be a value optimized using a simulator or the like, or may be a value learned by machine learning.

The reference frequency divider 520 divides the reference frequency. A signal corresponding to the reference frequency, for example, a pulse signal which has a frequency of the reference frequency generated by a global positioning system (GPS) signal or a global navigation satellite system (GNSS) signal is input to the reference frequency divider 520. Then, the reference frequency divider 520 divides the reference frequency by using the input signal. At this time, the reference frequency divider 520 may determine a frequency division ratio according to the operation band frequency of the device to be controlled by the first feedback control unit 500, similarly to the offset frequency divider 510. Such a frequency division ratio may be a value determined in advance for each device, may be a value optimized using a simulator or the like, or may be a value learned by machine learning.

The first phase comparator 530 detects the first error signal by comparing the signal corresponding to the carrier envelope offset frequency fceo with the signal corresponding to the reference frequency. More specifically, two signals of the signal output from the offset frequency divider 510 and the signal output from the reference frequency divider 520 may be input to the first phase comparator 530. Then, the first phase comparator 530 may detect the first error signal by comparing the signal output from the offset frequency divider 510 with the signal output from the reference frequency divider 520.

The first loop filter 540 outputs a first electric signal corresponding to the first error signal. The first loop filter 540 outputs, for example, the first electric signal obtained by converting the first error signal detected by the first phase comparator 530 into a DC voltage.

The first driver 550 controls, based on the first electric signal, a device capable of modifying the resonator length. For example, the first driver 550 feedback-controls the device capable of modifying the resonator length, according to the first electric signal output from the first loop filter 540.

Here, as described above, in the mode-locked fiber laser 20, the resonator length can be controlled by controlling the voltage applied to the piezoelectric element 272. Therefore, the first driver 550 may be a piezo driver which controls, based on the first electric signal, the piezoelectric element 272 to which the reflection mirror 260, which reflects the light emitted from the optical circulator 240 in the resonator and causes the light to be incident on the optical circulator 240 again, is attached.

As described above, in the mode-locked fiber laser 20, the resonator length can be controlled by controlling the pulse signal given to the stepping motor 274. Therefore, the first driver 550 may be a motor driver which controls, based on the first electric signal, the stepping motor 274 which moves, relative to the housing, the support member 265 which supports the reflection mirror 260 which reflects the light emitted from the optical circulator 240 in the resonator and causes the light to be incident on the optical circulator 240 again.

As described above, in the mode-locked fiber laser, the resonator length can be controlled by controlling the voltage applied to the optical modulator 230. Therefore, the first driver 550 may be a modulator driver which controls the optical modulator 230 in the resonator based on the first electric signal.

As described above, the first driver 550 may be one of the piezo driver, the motor driver, or the modulator driver, or a combination of these drivers. When the first driver 550 is constituted by a combination of a plurality of drivers, each of the offset frequency divider 510 and the reference frequency divider 520 may be provided with a plurality of frequency dividers which divide frequencies at different frequency division ratios for a plurality of devices to be controlled by the plurality of drivers.

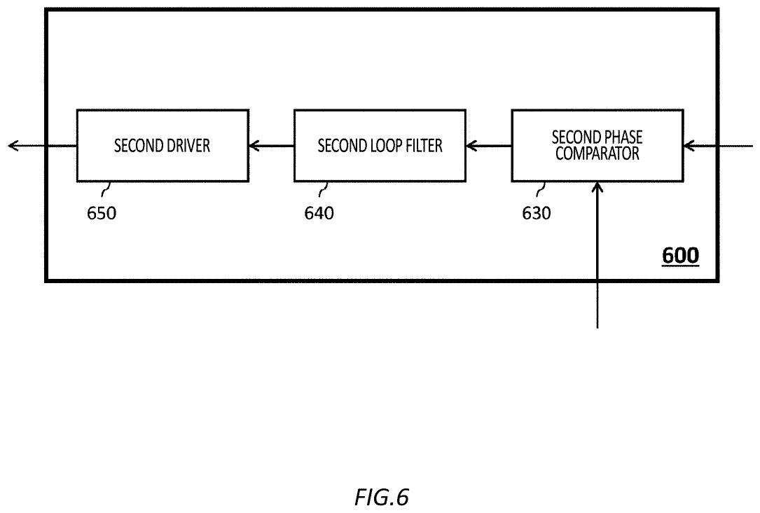

FIG. 6 illustrates a configuration example of the second feedback control unit 600 included in the frequency stabilization circuit 100 according to the present embodiment. The second feedback control unit 600 includes a second phase comparator 630, a second loop filter 640, and a second driver 650.

The second phase comparator 630 detects the second error signal by comparing the signal corresponding to the carrier envelope offset frequency fceo with the signal corresponding to the reference frequency. Two signals of a signal corresponding to the carrier envelope offset frequency fceo detected by the offset frequency detection unit 300, for example, a pulse signal which has a frequency of the carrier envelope offset frequency fceo and is another of the signals branched by the branching unit 350 and the signal corresponding to the reference frequency, for example, the pulse signal which has a frequency of the reference frequency generated by the GPS signal or the GNSS signal may be input to the second phase comparator 630. Then, the second phase comparator 630 may detect the second error signal by comparing the two signals.

The second loop filter 640 outputs a second electric signal corresponding to the second error signal. The second loop filter 640 outputs, for example, the second electric signal obtained by converting the second error signal detected by the second phase comparator 630 into a DC voltage.

The second driver 650 controls, based on the second electric signal, a laser diode serving as the excitation light source in the resonator. For example, the second driver 650 feedback-controls the laser diode serving as the excitation light source in the resonator, according to the second electric signal output from the second loop filter 640.

Here, as described above, in the mode-locked fiber laser 20, the excitation light power can be controlled by controlling the current applied to the first excitation light source 210 which is a pump laser diode. Therefore, the second driver 650 may be a laser diode driver which controls, based on the second electric signal, the first excitation light source 210 which generates the excitation light to be input into the resonator.

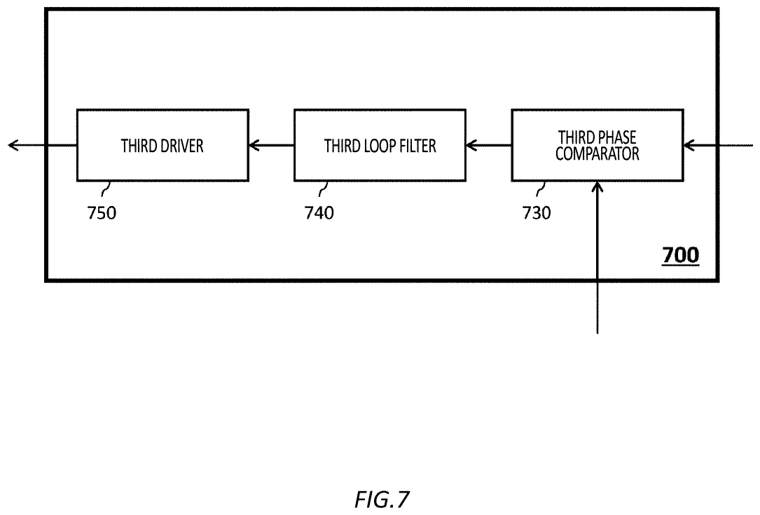

FIG. 7 illustrates a configuration example of the third feedback control unit 700 included in the frequency stabilization circuit 100 according to the present embodiment. The third feedback control unit 700 includes a third phase comparator 730, a third loop filter 740, and a third driver 750.

The third phase comparator 730 detects the third error signal by comparing the signal corresponding to the beat frequency fbeat with the signal corresponding to the reference frequency. Two signals of a signal corresponding to the beat frequency fbeat detected by the beat frequency detection unit 400, for example, a pulse signal which has a frequency of the beat frequency fbeat, and the signal corresponding to the reference frequency, for example, the pulse signal which has a frequency of the reference frequency generated by the GPS signal or the GNSS signal may be input to the third phase comparator 730. Then, the third phase comparator 730 may detect the third error signal by comparing the two signals.

The third loop filter 740 outputs a third electric signal corresponding to the third error signal. The third loop filter 740 outputs, for example, the third electric signal obtained by converting the third error signal detected by the third phase comparator 730 into a DC voltage.

The third driver 750 controls the optical modulator in the resonator based on the third electric signal. For example, the third driver 750 feedback-controls the optical modulator in the resonator, according to the third electric signal output from the third loop filter 740.

Here, as described above, in the mode-locked fiber laser 20, the resonator length can be controlled by controlling the voltage applied to the optical modulator 230. Therefore, the third driver 750 may be a modulator driver which controls the optical modulator 230 in the resonator based on the third electric signal.

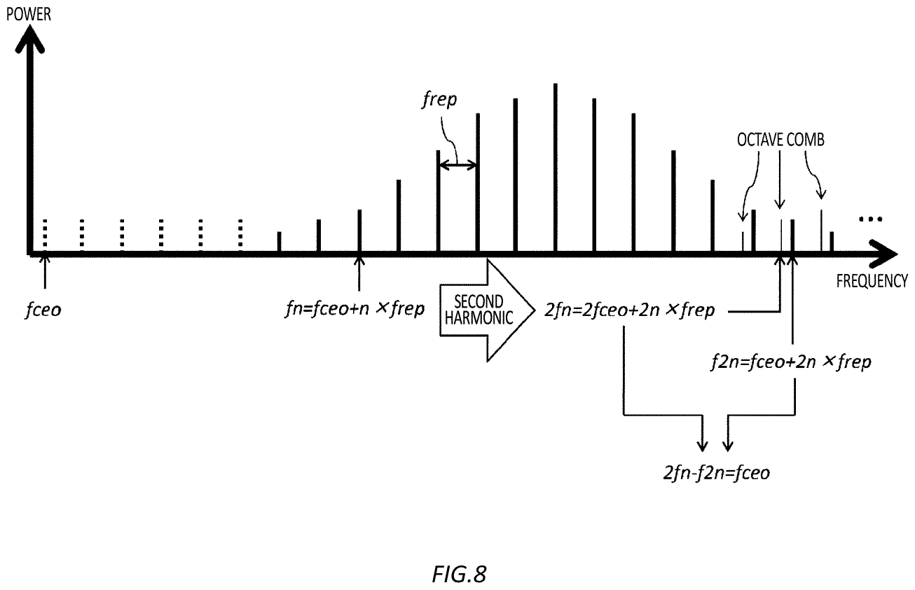

FIG. 8 illustrates a state where the carrier envelope offset frequency fceo is detected by the self-reference method. As illustrated in this drawing, when the output of the optical comb is Fourier-transformed and viewed in a frequency domain, the optical comb forms a comb-shaped spectrum consisting of a large number of modes at equal intervals. An nth mode frequency fn in the optical comb is expressed by fn=fceo+nxfrep. Here, frep represents a repetition frequency. fceo represents a frequency of a mode closest to 0 Hz when it is assumed that the spectrum of the optical comb extends to 0 Hz, and is called a carrier envelope offset frequency. n is an integer of about 1 million as a mode number.

Here, the second harmonic 2fn of the nth mode frequency fn in the optical comb is 2fn=2fceo+2n×frep. In addition, the 2nth mode frequency f2n in the optical comb is f2n=fceo+2n×frep. Therefore, the carrier envelope offset frequency fceo can be detected by subtracting the 2nth mode frequency f2n from the second harmonic 2fn of the nth mode frequency fn. The offset frequency detection unit 300 can detect the carrier envelope offset frequency fceo by using, for example, such an f-2f self-reference method.

When the mode-locked fiber laser 20 which outputs such an optical comb is used as the optical comb light source, simultaneous locking of the carrier envelope offset frequency fceo and the beat frequency fbeat is required.

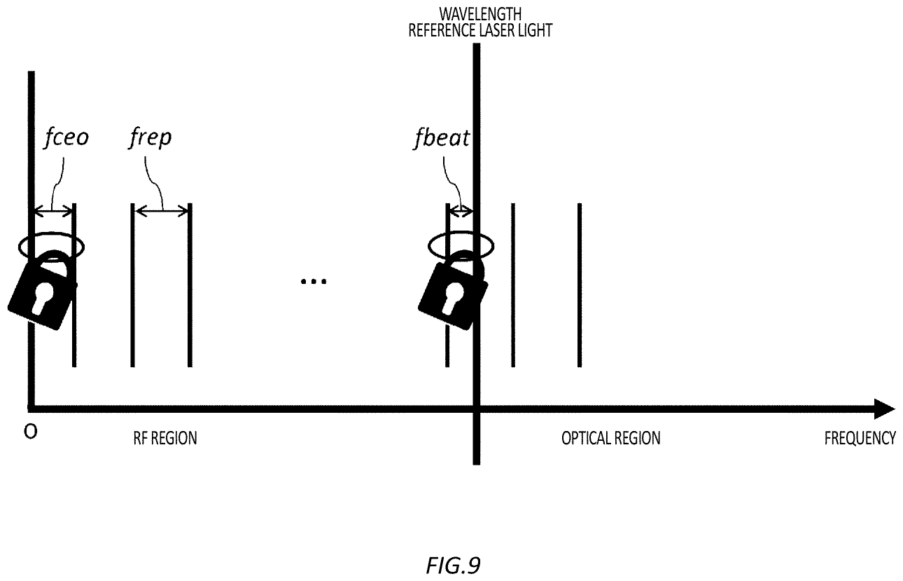

FIG. 9 illustrates a state where the carrier envelope offset frequency fceo and the beat frequency fbeat are simultaneously locked. As illustrated in this drawing, the carrier envelope offset frequency fceo and the beat frequency fbeat are simultaneously locked, so that the frequency of each mode is stabilized, and thus, the mode-locked fiber laser 20 can be used as the optical comb light source. However, there are the following problems in simultaneously locking the carrier envelope offset frequency fceo and the beat frequency fbeat.

In general, in locking the carrier envelope offset frequency fceo, a phase difference between the signal corresponding to the carrier envelope offset frequency fceo and the signal corresponding to the reference frequency is detected by a phase comparator, and phase synchronization is performed by changing a current value of the pump laser diode. That is, the carrier envelope offset frequency fceo is changed by using a change in a refractive index of the optical fiber due to a change in the excitation light power, and the phase synchronization is performed such that the reference frequency and the carrier envelope offset frequency fceo match. At this time, in order to perform the phase synchronization, it is necessary to sufficiently increase an S/N ratio of the carrier envelope offset frequency fceo. However, when the current value of the pump laser diode is changed in order to maintain a phase synchronization state, the S/N ratio also deteriorates according to a change in an oscillation state of the mode-locked laser such as optical pulse output power and an optical pulse width, and thus it becomes difficult to maintain the phase synchronization state. In addition, since a variable range of the carrier envelope offset frequency fceo (a control range of the pump laser diode) is narrow, when the resonator length greatly changes due to an environmental temperature fluctuation or the like, the control range is exceeded and the S/N ratio also deteriorates.

In addition, in simultaneously locking the carrier envelope offset frequency fceo and the beat frequency fbeat, the voltage applied to the optical modulator is changed in order to stabilize the beat frequency fbeat, so that the resonator length changes, and accordingly, the carrier envelope offset frequency fceo and the beat frequency fbeat also fluctuate. For this reason, in order to stabilize the carrier envelope offset frequency fceo, it is necessary to greatly change the current value of the pump laser diode, and thus the S/N ratio also deteriorates.

Conventionally, in stabilizing the carrier envelope offset frequency fceo, in order not to exceed the control range of the pump laser diode, a temperature of the laser housing is controlled by a Peltier element or the like, and the resonator length is controlled, thereby achieving the stabilization. However, in the conventional method, a heat capacity of a case housing a laser or the like is large, and thus, in response to an abrupt environmental temperature fluctuation, it has been difficult to perform temperature control at high speed to prevent the phase synchronization of the carrier envelope offset frequency fceo from being disrupted.

On the other hand, the frequency stabilization circuit 100 according to the present embodiment includes the first feedback control unit 500, the second feedback control unit 600, and the third feedback control unit 700, and controls the resonator length in the mode-locked fiber laser 20 based on the first error signal indicating the error of the carrier envelope offset frequency fceo with respect to the reference frequency, controls the excitation light power in the mode-locked fiber laser 20 based on the second error signal indicating the error of the carrier envelope offset frequency fceo with respect to the reference frequency, and controls the resonator length in the mode-locked fiber laser 20 based on the third error signal indicating the error of the beat frequency fbeat with respect to the reference frequency.

As described above, the frequency stabilization circuit 100 according to the present embodiment includes two feedback loops of a loop for controlling the excitation light power and a loop for controlling the resonator length in order to achieve the phase synchronization between the carrier envelope offset frequency fceo and the reference frequency, and a feedback loop for controlling the resonator length in order to achieve the phase synchronization between the beat frequency fbeat and the reference frequency, and thus the frequency stabilization circuit and the frequency stabilization method can be provided in which the stabilization can be achieved by performing control such that a control current of the pump laser diode is always constant and suppressing the deterioration of the S/N of the carrier envelope offset frequency fceo due to the change in the excitation light, thereby allowing sufficient tracking of even the abrupt environmental temperature fluctuation.

More specifically, the frequency stabilization circuit 100 according to the present embodiment includes, as a lock mechanism of the carrier envelope offset frequency fceo, a path (first feedback control unit 500) for feedback-controlling the resonator length in parallel with a path (second feedback control unit 600) for feedback-controlling the excitation light power, independently. Accordingly, according to the frequency stabilization circuit 100 according to the present embodiment, by adopting different paths in parallel, it is possible to cope with a case where a control frequency for a device capable of modifying the excitation light power is different from a control frequency for a device capable of modifying the resonator length. More specifically, according to the frequency stabilization circuit 100 of the present embodiment, for example, by including the offset frequency divider 510 and the reference frequency divider 520 in the first feedback control unit 500, the control frequency for the device capable of modifying the resonator length can be adjusted to an operation band frequency of the device, independently of the control frequency for the device capable of modifying the excitation light power.

In addition, the frequency stabilization circuit 100 according to the present embodiment may have, as the lock mechanism of the carrier envelope offset frequency fceo, a loop for feedback-controlling the piezoelectric element 272. Here, for example, when a change in the resonator length caused by applying a voltage to the piezoelectric element 272 is ΔL, a change Δfrep_pzt of the repetition frequency frep of the mode-locked fiber laser 20 is expressed by a following expression. Here, c represents a light velocity, n represents a refractive index with respect to an optical carrier frequency of a fiber, and L represents the resonator length.

$$Δ frep\_pzt = c Δ L / {nL}^{2} \qquad Expression 1$$

Furthermore, the carrier envelope offset frequency fceo and the repetition frequency frep have a relationship of a following expression. Here, Δϕ represents a phase shift for each pulse.

$$Δ φ = 2 π ( fceo / frep ) \qquad Expression 2$$

Here, when it is assumed that the phase synchronization state is established, Δϕ is constant. In this state, when the repetition frequency frep changes by Δfrep_env due to an abrupt temperature fluctuation, in order to maintain a locked state of the carrier envelope offset frequency fceo, it is necessary to change each of the carrier envelope offset frequency fceo and the repetition frequency frep so as to satisfy a following expression. Here, Δfrep and Δfceo respectively represent changes in the carrier envelope offset frequency fceo and the repetition frequency frep due to the control of the pump laser diode.

$$Expression 3$$

$$\begin{matrix}Δ φ = const = 2 π ( fceo / frep ) \\ = 2 π ( fceo / frep ) ( 1 + Δ fceo / fceo - ( Δ frep + Δ frep\_env ) / frep )\end{matrix}$$

In a case of the abrupt temperature fluctuation, the S/N ratio of the carrier envelope offset frequency fceo deteriorates at a time of compensation by Δfceo and Δfrep. In this regard, the frequency stabilization circuit 100 according to the present embodiment compensates for Δfrep_env caused by the abrupt temperature fluctuation with Δfrep_pzt in Expression 1. Accordingly, according to the frequency stabilization circuit 100 according to the present embodiment, it is possible to reduce Δfceo and Δfrep for compensation, and thus, it is possible to suppress a necessary control current value of the pump laser.

Note that, in the above description, a case where the resonator length is changed by controlling the piezoelectric element 272 has been described as an example, but the same applies to a case where the resonator length is changed by controlling the stepping motor 274 or the optical modulator 230.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the description of the claims that the form to which such alterations or improvements are made can be included in the technical scope of the present invention.

It should be noted that the operations, procedures, steps, stages, and the like of each process performed by an apparatus, system, program, and method shown in the claims, the specification, or the drawings can be realized in any order as long as the order is not indicated by “prior to,” “before,” or the like and as long as the output from a previous process is not used in a later process. Even if the operation flow is described by using phrases such as “first” or “next” for the sake of convenience in the claims, specification, and drawings, it does not necessarily mean that the process must be performed in this order.

### EXPLANATION OF REFERENCES

10: optical comb generator;
20: mode-locked fiber laser;
100: frequency stabilization circuit;
200: multi-port optical coupler;
210: first excitation light source;
215: first wavelength division multiplexing filter;
220: first optical amplification fiber;
230: optical modulator;
240: optical circulator;
250: collimating lens;
260: reflection mirror;
265: support member;
270: actuator;
272: piezoelectric element;
274: stepping motor;
280: output optical coupler;
290: optical brancher;
300: offset frequency detection unit;
310: octave comb generation unit;
311: second excitation light source;
313: second wavelength division multiplexing filter;
315: second optical amplification fiber;
317: third excitation light source;
319: third wavelength division multiplexing filter;
320: highly nonlinear fiber;
330: offset frequency observation unit;
331: lens;
333: PPLN waveguide;
335: first photodiode;
400: beat frequency detection unit;
410: optical multiplexing unit;
411: fourth optical amplification fiber;
413: fourth excitation light source;
415: fourth wavelength division multiplexing filter;
417: optical band pass filter;
420: wavelength reference laser;
425: optical multiplexer;
430: beat frequency observation unit;
431: second photodiode;
500: first feedback control unit;
510: offset frequency divider;
520: reference frequency divider;
530: first phase comparator;
540: first loop filter;
550: first driver;
600: second feedback control unit;
630: second phase comparator;
640: second loop filter;
650: second driver;
700: third feedback control unit;
730: third phase comparator;
740: third loop filter; and
750: third driver.

What is claimed is:

1. A frequency stabilization circuit comprising:
an offset frequency detection unit which detects a carrier envelope offset frequency in an optical comb output from a resonator of a mode-locked fiber laser;
a beat frequency detection unit which detects a beat frequency generated by interference between an optical spectrum as a reference in the optical comb and wavelength reference laser light;
a first feedback control unit which controls a resonator length in the mode-locked fiber laser based on a first error signal indicating an error of the carrier envelope offset frequency with respect to a reference frequency;
a second feedback control unit which controls excitation light power in the mode-locked fiber laser based on a second error signal indicating an error of the carrier envelope offset frequency with respect to the reference frequency; and
a third feedback control unit which controls a resonator length in the mode-locked fiber laser based on a third error signal indicating an error of the beat frequency with respect to the reference frequency.

2. The frequency stabilization circuit according to claim 1, wherein
the first feedback control unit includes
a first phase comparator which detects the first error signal by comparing a signal corresponding to the carrier envelope offset frequency with a signal corresponding to the reference frequency,
a first loop filter which outputs a first electric signal corresponding to the first error signal, and
a first driver which controls, based on the first electric signal, a device capable of modifying the resonator length.

3. The frequency stabilization circuit according to claim 2, wherein
the first feedback control unit further includes
an offset frequency divider which divides the carrier envelope offset frequency, and
a reference frequency divider which divides the reference frequency, and
the first phase comparator detects the first error signal by comparing a signal output from the offset frequency divider with a signal output from the reference frequency divider.

4. The frequency stabilization circuit according to claim 2, wherein the first driver controls, based on the first electric signal, a piezoelectric element to which a reflection mirror, which reflects light emitted from an optical circulator in the resonator and causes the light to be incident on the optical circulator again, is attached.

5. The frequency stabilization circuit according to claim 2, wherein the first driver controls, based on the first electric signal, a stepping motor which moves, relative to a housing, a support member which supports a reflection mirror which reflects light emitted from an optical circulator in the resonator and causes the light to be incident on the optical circulator again.

6. The frequency stabilization circuit according to claim 2, wherein the first driver controls an optical modulator in the resonator based on the first electric signal.

7. The frequency stabilization circuit according to claim 1, further comprising a branching unit which branches a signal corresponding to the carrier envelope offset frequency into at least two, supplies one to the first feedback control unit, and supplies another to the second feedback control unit.

8. The frequency stabilization circuit according to claim 1, wherein
the second feedback control unit includes
a second phase comparator which detects the second error signal by comparing a signal corresponding to the carrier envelope offset frequency with a signal corresponding to the reference frequency,
a second loop filter which outputs a second electric signal corresponding to the second error signal, and
a second driver which controls, based on the second electric signal, a laser diode serving as an excitation light source in the resonator.

9. The frequency stabilization circuit according to claim 1, wherein
the third feedback control unit includes
a third phase comparator which detects the third error signal by comparing a signal corresponding to the beat frequency with a signal corresponding to the reference frequency,
a third loop filter which outputs a third electric signal corresponding to the third error signal, and
a third driver which controls an optical modulator in the resonator based on the third electric signal.

10. The frequency stabilization circuit according to claim 1, wherein
the offset frequency detection unit includes
an octave comb generation unit which expands an optical spectrum of the optical comb by an octave or more to generate an octave comb, and
an offset frequency observation unit which observes the carrier envelope offset frequency by using the octave comb.

11. The frequency stabilization circuit according to claim 1, wherein
the beat frequency detection unit includes
an optical multiplexing unit which multiplexes the optical comb and the wavelength reference laser light, and
a beat frequency observation unit which observes the beat frequency by using the multiplexed light.

12. An optical comb generator comprising:
the mode-locked fiber laser; and
the frequency stabilization circuit according to claim 1.

13. An optical comb generator comprising:
the mode-locked fiber laser; and
the frequency stabilization circuit according to claim 2.

14. An optical comb generator comprising:
the mode-locked fiber laser; and
the frequency stabilization circuit according to claim 3.

15. The optical comb generator according to claim 12, wherein
the mode-locked fiber laser includes, in the resonator,
an optical circulator which emits, from a second port, light incident on a first port and emits, from a third port, light incident on the second port,
a reflection mirror which reflects light emitted from the second port of the optical circulator and causes the light to be incident on the second port of the optical circulator again, and
an actuator which is capable of modifying a position of the reflection mirror along an optical axis direction.

16. The optical comb generator according to claim 15, wherein the actuator is a piezoelectric element to which the reflection mirror is attached.

17. The optical comb generator according to claim 15, wherein the actuator is a stepping motor which moves, relative to a housing, a support member which supports the reflection mirror.

18. The optical comb generator according to claim 12, wherein the mode-locked fiber laser is a figure-eight shaped laser in which two input ports and two output ports of a multi-port optical coupler are connected in a figure-eight shape by polarization maintaining fibers.

19. The optical comb generator according to claim 18, wherein
the mode-locked fiber laser includes, in the resonator,
an excitation light source which generates excitation light,
a wavelength division multiplexing filter to which the excitation light is input,
an optical amplification fiber which amplifies light by being excited by the excitation light,
an optical modulator which modulates a phase of light propagating in the resonator, and
an output optical coupler which outputs the optical comb generated in the resonator.

20. A frequency stabilization method comprising:
detecting a carrier envelope offset frequency in an optical comb output from a resonator of a mode-locked fiber laser;
detecting a beat frequency generated by interference between an optical spectrum as a reference in the optical comb and wavelength reference laser light;
controlling a resonator length in the mode-locked fiber laser based on a first error signal indicating an error of the carrier envelope offset frequency with respect to a reference frequency;
controlling excitation light power in the mode-locked fiber laser based on a second error signal indicating an error of the carrier envelope offset frequency with respect to the reference frequency; and
controlling a resonator length in the mode-locked fiber laser based on a third error signal indicating an error of the beat frequency with respect to the reference frequency.
